(19) United States
(12) Patent Application Publication
(10) Pub. No.: US 2025/0155959 A1
(43) Pub. Date: May 15, 2025

(54) Bias in powering down links to a switch (in redundant topologies), allow full switch shutdown for power saving

(71) Applicant: Cisco Technology, Inc., San Jose, CA (US)

(72) Inventors: Sanjay K Hooda, Pleasanton, CA (US); Swati Garg, Cupertino, CA (US); Madhavan Kasthurirangan, Palo Alto, CA (US); Shyamsundar N. Maniyar, San Jose, CA (US)

(21) Appl. No.: 18/508,120

(22) Filed: Nov. 13, 2023

(51) Int. Cl. G06F 1/3296; G06F 1/3206

(52) U.S. Cl. CPC G06F 1/3296; G06F 1/3206

(57) ABSTRACT

Devices, networks, systems, methods, and processes for determining a dynamic bias associated with a network device are described herein. A communication network may include multiple network devices and multiple links between the network devices. The communication network may further include a controller that monitors the communication network to determine dynamic changes in a network topology of the communication network. The controller determines the dynamic bias associated with the network device based on the dynamic changes. The controller generates and transmits a control signal based on the dynamic bias. The network device receives the control signal and switches an operation state of the network device, or an operation state of the links connected to the network device, based on the control signal. The controller can thereby achieve reduction in power consumption of the communication network by switching off the network device without affecting reliability and availability of the communication network.

The present disclosure relates to communication networks. More particularly, the present disclosure relates to dynamically powering down switches and links to the switches.

### BACKGROUND

Many modern communication networks incorporate redundancy to ensure high network availability and reliability. This redundancy is often incorporated by connecting multiple redundant network components such as switches and routers. Such redundancy helps in minimizing a downtime of a communication network and maintaining network connectivity in events of hardware failures or maintenance activities. However, while the redundancy is crucial for the network availability and reliability, the redundancy can also lead to increased power consumption and operational costs.

To address environmental and economic concerns associated with the redundant network components, many organizations have implemented various power-saving solutions. These power-saving solutions aim to reduce energy consumption and minimize environmental footprint of the communication network. Once such power-saving solution aims to reduce the energy consumption by powering down redundant switches. This power-saving solution may lead to service disruptions and reduced network resilience. For example, a switch may run a critical application or service while being connected to a less-used link, and hence, powering down the switch may lead to a service disruption. Typically, conventional power-saving solutions rely merely on traffic load on the links without considering other network parameters that might adversely affect the network resilience.

An effective power-saving solution must strike a balance between sustainability and the network reliability. The balance can be maintained by strategically powering down some of the network components while ensuring that the network reliability is not affected. The conventional power-saving solutions fail to strike such a balance. Therefore, there is a need for a dynamic and intelligent power-saving solution that can identify which of the redundant components can be safely powered down without compromising the network availability and resilience.

### SUMMARY OF THE DISCLOSURE

Systems and methods for dynamically powering down switches and links to the switches in accordance with embodiments of the disclosure are described herein. In some embodiments, a device, includes a processor, a memory communicatively coupled to the processor, and a dynamic sustainability logic. The logic is configured to monitor a network including a plurality of network devices, for one or more dynamic changes in a network topology of the network, monitor a state of one or more links connected to at least one network device of the plurality of network devices, determine a dynamic bias associated with the at least one network device based on the one or more dynamic changes and the state of the one or more links, and generate a device power control signal based on the determined dynamic bias, wherein the device power control signal is indicative of dynamically switching an operation state of the at least one network device.

In some embodiments, the dynamic sustainability logic is further configured to transmit the device power control signal to the at least one network device.

In some embodiments, the at least one network device dynamically switches the operation state based on the device power control signal.

In some embodiments, the operation state includes an on state, an off state, or a low-power state.

In some embodiments, the dynamic sustainability logic is further configured to determine a wake-up time for the at least one network device based on the dynamic bias.

In some embodiments, the device power control signal is further indicative of the wake-up time for the at least one network device.

In some embodiments, the at least one network device switches on after the wake-up time based on the device power control signal.

In some embodiments, the dynamic sustainability logic is further configured to retrieve historical usage data of the at least one network device, predict a future usage pattern of the at least one network device based on the historical usage data, and adjust the dynamic bias based on the predicted future usage pattern of the at least one network device.

In some embodiments, the dynamic sustainability logic is further configured to adjust the wake-up time based on the predicted future usage pattern of the at least one network device.

In some embodiments, the dynamic sustainability logic is further configured to monitor network heuristics for the network, and adjust the dynamic bias based on the network heuristics.

In some embodiments, the network heuristics include one or more of current usage of the plurality of network devices, power saving capabilities of the plurality of network devices, current usage of a plurality of links between the plurality of network devices, or maximum bandwidths of the plurality of links.

In some embodiments, the dynamic sustainability logic is further configured to adjust the dynamic bias such that the dynamic bias is raised when a link of the one or more links connected to the at least one network device is switched off.

In some embodiments, the dynamic sustainability logic is further configured to monitor the one or more dynamic changes including a change in a number of the plurality of network devices or a change in a number of a plurality of links between the plurality of network devices.

In some embodiments, a method includes monitoring a network including a plurality of network devices, for one or more dynamic changes in a network topology of the network, monitoring a state of one or more links connected to at least one network device of the plurality of network devices, determining a dynamic bias associated with the at least one network device based on the one or more dynamic changes and the state of the one or more links, generating a device power control signal based on the determined dynamic bias, wherein the device power control signal is indicative of dynamically switching an operation state of the at least one network device, and transmitting the device power control signal to the at least one network device.

In some embodiments, a method further includes retrieving historical usage data of the at least one network device, predicting a future usage pattern of the at least one network device based on the historical usage data, and adjusting the dynamic bias based on the predicted future usage pattern of the at least one network device.

In some embodiments, a device includes a processor, a memory communicatively coupled to the processor, and a dynamic sustainability logic. The logic is configured to monitor a network including a plurality of network devices, for one or more dynamic changes in a network topology of the network, monitor a state of one or more links connected to at least one network device of the plurality of network devices, determine a dynamic bias associated with the at least one network device based on the one or more dynamic changes and the state of the one or more links, generate a control signal based on the determined dynamic bias, and transmit the control signal to the at least one network device.

In some embodiments, the control signal is indicative of dynamically switching an operation state of the at least one network device.

In some embodiments, the at least one network device dynamically switches the operation state based on the control signal.

In some embodiments, the control signal is indicative of dynamically switching the state of the one or more links connected to the at least one network device.

In some embodiments, the at least one network device dynamically switches on or switches off the one or more links based on the control signal.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of a communication network, in accordance with various embodiments of the disclosure;

FIG. 2 is a conceptual illustration of redundant devices and links in a communication network, in accordance with various embodiments of the disclosure;

FIG. 3 is a schematic block diagram of an example architecture for a network fabric, in accordance with various embodiments of the disclosure;

FIG. 4 is a flowchart depicting a process for transmitting a device power control signal, in accordance with various embodiments of the disclosure;

FIG. 5 is a flowchart depicting a process for adjusting a dynamic bias associated with a network device, in accordance with various embodiments of the disclosure;

FIG. 6 is a flowchart depicting a process for adjusting a dynamic bias associated with a network device, in accordance with various embodiments of the disclosure;

FIG. 7 is a flowchart depicting a process for switching states of one or more links and

raising a dynamic bias associated with a network device, in accordance with various embodiments of the disclosure; and

FIG. 8 is a conceptual block diagram of a device suitable for configuration with a dynamic sustainability logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that determine a dynamic bias associated with a network device in a communication network. In a communication network including multiple network devices, there can be one or more redundant network devices. Further, the communication network may have a network topology that can change dynamically. In some embodiments, the network topology may face one or more dynamic changes, such as, but not limited to, addition of one or more new network devices, removal of one or more existing network devices, powering down the one or more existing network devices, or switching the one or more existing network devices to a sleep state or a low-power state, for example. The network devices can have multiple links between the network devices. A change in a state of the links may further contribute to the dynamic changes in the network topology.

In many embodiments, the communication network may also include a controller in communication with the network devices. In some embodiments, the controller may be implemented in one of the network devices. In certain embodiments, the controller can be a separate network device in the communication network. In more embodiments, the controller may be a separate device in another network. The controller can monitor the communication network for the dynamic changes. The controller may include a dynamic sustainability logic to dynamically determine and adjust the dynamic bias associated with the network device. The controller can further generate a device control signal or a control signal to control the network device or the links connected to the network device. The network device can receive the device control signal or the control signal and can dynamically switch one or more operation states of the network device based on the device control signal or the control signal. The network device can also switch one or more operation states of the links connected to the network device based on the control signal. In some more embodiments, the operation states of the network device may include an on state, an off state, or a low-power state, for example. In numerous embodiments, the operation states of the links can include an on state and an off state, for example. In many further embodiments, the dynamic bias associated with the network device at a time instant can be high or relatively higher if the network device can be switched to the off state or the low-power state at that time instant, for example. In still more embodiments, the dynamic bias associated with the network device may be constantly or periodically adjusted by the controller, or further, a wake-up time for the network device may also be constantly or periodically adjusted by the controller.

In a number of embodiments, the controller can determine the dynamic bias associated with the network device based on the dynamic changes in the network topology of the communication network. The controller may generate the device control signal, or the control signal based on the dynamic bias. In some embodiments, the controller can further determine the wake-up time for the network device. In numerous embodiments, the dynamic bias and the wake-up time can be dynamically adjusted in real-time or near real-time by the controller when a change in the network topology of the communication network is detected by the controller. The device control signal may be further indicative of the wake-up time of the network device. The network device can receive the device power control signal and switch the operation state of the network device to the off state, or the low-power state based on the device control signal. Thereafter, after the wake-up time has passed, the network device can switch the operation state of the network device to the on state.

In various embodiments, the controller may adjust the wake-up time of the device in various ways. In some embodiments, the controller can retrieve historical usage data of the network device. In certain embodiments, the historical usage data may include bandwidth usage information for inbound and outbound traffic at the network device, latency information including round-trip time for packets, packet loss information, jitter, information about processor and memory usage of the network device, interface utilization of the network device, temperature and hardware health of the network device, security logs and intrusion at the network device, user activity in the network device, or power consumption by the network device, for example. The historical usage data can further include utilization times of the network device, i.e., the times at which the network device was utilized. In more embodiments, the historical usage data may be stored in the network device or in the controller, for example. In some more embodiments, the historical usage data can be stored in an external storage device or a database in the communication network or external to the communication network, for example. The controller may predict a future usage pattern of the network device based on the historical usage data of the network device. In numerous embodiments, the prediction of the future usage pattern of the network device can include capacity and resource planning for the network device, forecasting power consumption of the network device, forecasting updates to the network device, forecasting compliance audits scheduled for the network device, forecasting application or service demand for the network device, predicting security threats for the network device, or growth in data traffic through the network device, for example. The controller can adjust the wake-up time for the network device based on the predicted future usage pattern of the network device. In many further embodiments, the controller may predict a time when the usage of the network device would exceed a predetermined threshold usage, and adjust the wake-up time such that the network device switches on when the usage of the network device is predicted to be increased, for example.

In various embodiments, the controller can monitor network heuristics of the communication network. In some embodiments, the network heuristics may include current usage of the network device, including the inbound and outbound traffic at the network device, or processor and memory usage in the network device, for example. In certain embodiments, the network heuristics may further include power saving capabilities of the network device, including energy efficiency of the network device, low-power or sleep states of the network device, or scheduled power management functions in the network device, for example. In more embodiments, the network heuristics can include current usage of the links between the network devices, including traffic engineering, load balancing, or fault tolerance functions for the links, for example. In some more embodiments, the network heuristics may include maximum bandwidths of the links, including Quality of Service for the links and cost optimization for the links, for example. The controller may adjust the dynamic bias associated with the network device based on the network heuristics. In numerous embodiments, the controller may lower the dynamic bias associated with the network device when the current usage of the network device is high, or may lower the dynamic bias associated with the network device when the current usage of the network device is low, for examples. In many further embodiments, the controller can lower the dynamic bias associated with the network device when the current usage of the links connected to the network device is high, or can lower the dynamic bias associated with the network device when the current usage of the links connected to the network device is low, for examples.

In additional embodiments, the controller may adjust the dynamic bias such that the dynamic bias is raised when a link of the one or more links connected to the network device is switched off. In some embodiments, the network device can dynamically switch the states of the links connected to the network device based on the control signal received from the controller. In that, the network device may switch on the one or more links or may switch off the one or more links based on the control signal. In some embodiments, the controller may adjust the dynamic bias associated with the network device after the network device switches on or switches off the one or more links, for example.

Advantageously, utilization of dynamic biases associated with the network devices in the communication network to change the operational states of the network devices may strike a balance between redundancy and sustainability. That is, the controller can facilitate control over which network devices can be switched off or switched to the low-power mode to reduce the power consumption, without affecting network reliability and availability. Further, utilization of the wake-up times for the network devices can ensure that the network devices can be up and running when required. Thus, the sustainability of the communication network can be improved without causing service disruptions in the communication network.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

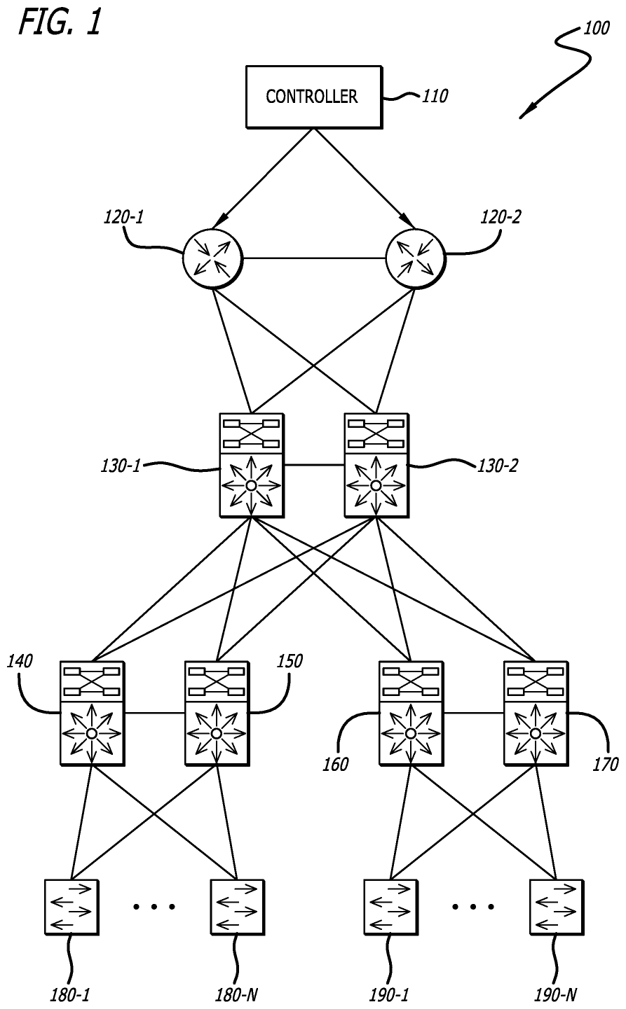

Referring to FIG. 1, a conceptual illustration of a communication network 100, in accordance with various embodiments of the disclosure is shown. The communication network 100 may include a controller 110, a first router 120-1, a second router 120-2, a first core switch 130-1, a second core switch 130-2, a plurality of distribution switches including first through fourth distribution switches 140-170, a first set of access switches 180-1-180-N, and a second set of access switches 190-1-190-N. The first set of access switches 180-1-180-N may be connected to the first and second distribution switches 140 and 150. The second set of access switches 190-1-190-N may be connected to the third and fourth distribution switches 160 and 170. In some embodiments, the first router 120-1, the second router 120-2, the first core switch 130-1, the second core switch 130-2, and the first through fourth distribution switches 140-170 may be interconnected. In certain embodiments, the controller 110 can be connected to the first router 120-1 and the second router 120-2. In more embodiments, the controller 110 can be connected to any one or more of: the first router 120-1, the second router 120-2, the first core switch 130-1, the second core switch 130-2, the first through fourth distribution switches 140-170, the first set of access switches 180-1-180-N, or the second set of access switches 190-1-190-N (may also be collectively referred to as “network devices 120-190”).

In many embodiments, the communication network 100 can include multiple links or multiple redundant links between the network devices 120-190. In some embodiments, the controller 110 may include a dynamic sustainability logic. In certain embodiments, the dynamic sustainability logic can be included in any one or more of the network devices 120-190. In more embodiments, the controller 110 can be external to the communication network 100. The communication network 100 may have a network topology that can change dynamically. In some more embodiments, the dynamic changes may include addition of one or more new switches, removal of one or more existing switches, powering down the one or more existing switches, or switching the one or more existing switches to a sleep state or a low-power state, for example. The dynamic changes may also include changes in one or more states of the links or the redundant links, for example. The controller 110 can monitor the communication network 100 to detect the dynamic changes in the network topology of the communication network 100. The controller 110 may determine dynamic biases associated with each of the network devices 120-190 based on the dynamic changes in the network topology. In numerous embodiments, any one of the network devices 120-190 may include the dynamic sustainability logic and may further monitor the communication network 100, detect the dynamic changes in the network topology of the communication network 100, or determine the dynamic biases associated with each of the network devices 120-190 based on the dynamic changes in the network topology.

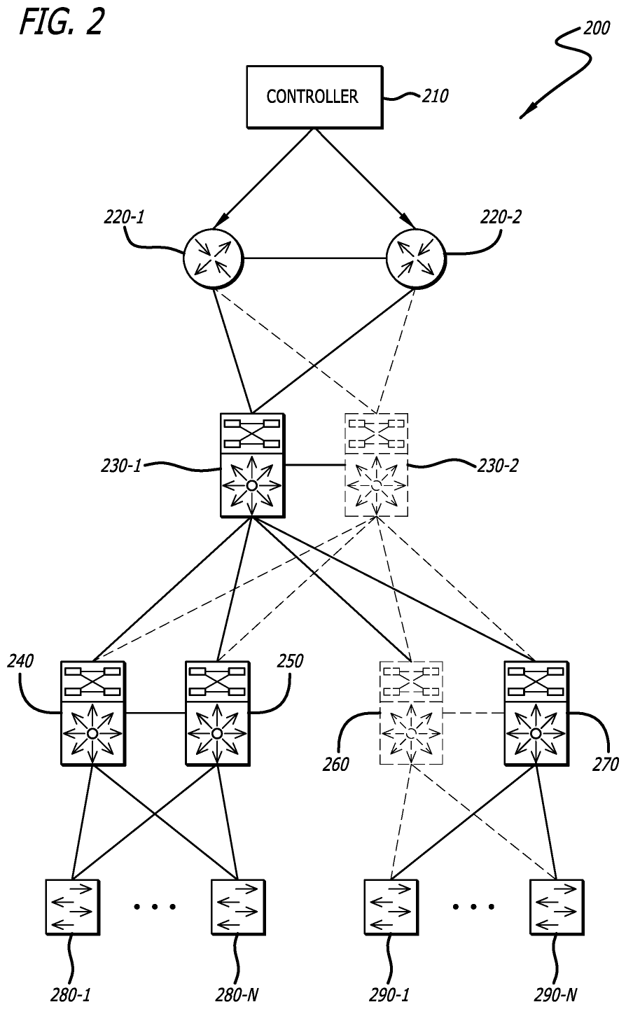

Although a specific embodiment for the communication network 100 for carrying out the various steps, processes, methods, and operations described herein is discussed with respect to FIG. 1, any of a variety of systems and/or processes may be utilized in accordance with embodiments of the disclosure. For example, the controller 110 may be within the communication network 100 or external to the communication network 100, or the dynamic sustainability logic can be implemented in the controller 110 or in any of the network devices 120-190. The elements depicted in FIG. 1 may also be interchangeable with other elements of FIGS. 2-8 as required to realize a particularly desired embodiment.

Referring to FIG. 2, a conceptual illustration of redundant devices and links in a communication network 200, in accordance with various embodiments of the disclosure is shown. The communication network 200 may include a controller 210, a first router 220-1, a second router 220-2, a first core switch 230-1, a second core switch 230-2, a plurality of distribution switches including first through fourth distribution switches 240-270, a first set of access switches 280-1-280-N, and a second set of access switches 290-1-290-N. The first set of access switches 280-1-2180-N may be connected to the first and second distribution switches 240 and 250. The second set of access switches 290-1-290-N may be connected to the third and fourth distribution switches 260 and 270. In some embodiments, the first router 220-1, the second router 220-2, the first core switch 230-1, the second core switch 230-2, and the first through fourth distribution switches 240-270 may be interconnected. In certain embodiments, the controller 210 can be connected to the first router 220-1 and the second router 220-2. In more embodiments, the controller 210 can be connected to any one or more of: the first router 220-1, the second router 220-2, the first core switch 230-1, the second core switch 230-2, the first through fourth distribution switches 240-270, the first set of access switches 280-1-280-N, or the second set of access switches 290-1-290-N (may also be collectively referred to as “network devices 220-290”).

In many embodiments, the controller 210 can monitor the communication network 200 to detect the dynamic changes in the network topology of the communication network 200. The controller 210 may determine dynamic biases associated with each of the network devices 220-290 based on the dynamic changes in the network topology. In some embodiments, the controller 210 may generate a first dynamic bias for the second core switch 230-2 and a second dynamic bias for the third distribution switch 260 based on the dynamic changes in the network topology. The controller 210 can further generate a first device control signal and a second device control based on the first dynamic bias and the second dynamic bias respectively. The controller 210 may transmit the first device control signal to the second core switch 230-2 and the second device control signal to the third distribution switch 260. The second core switch 230-2 can receive the first device control signal and can switch to the off state based on the first device control signal. The third distribution switch 260 may receive the second device control signal and may switch to the off state based on the second device control signal.

In a number of embodiments, the controller 210 may determine a first wake-up time for the second core switch 230-2 and a second wake-up time for the third distribution switch 260. The first device power control signal may be indicative of the first wake-up time and the second device power control signal may be indicative of the second wake-up time. The second core switch 230-2 can receive the first device power control signal and switch to the off state, and after the first wake-up time has passed, the second core switch 230-2 can switch back to the on state without requiring any communication from the controller 210. Similarly, the third distribution switch 260 can receive the second device power control signal and switch to the off state, and after the second wake-up time has passed, the third distribution switch 260 can switch back to the on state without requiring any communication from the controller 210.

Although a specific embodiment for the communication network 200 for carrying out the various steps, processes, methods, and operations described herein is discussed with respect to FIG. 2, any of a variety of systems and/or processes may be utilized in accordance with embodiments of the disclosure. For example, the communication network 200 may facilitate dynamically switching the operation states of the network devices 220-290 after corresponding wake-up times. The elements depicted in FIG. 2 may also be interchangeable with other elements of FIG. 1 and FIGS. 3-8 as required to realize a particularly desired embodiment.

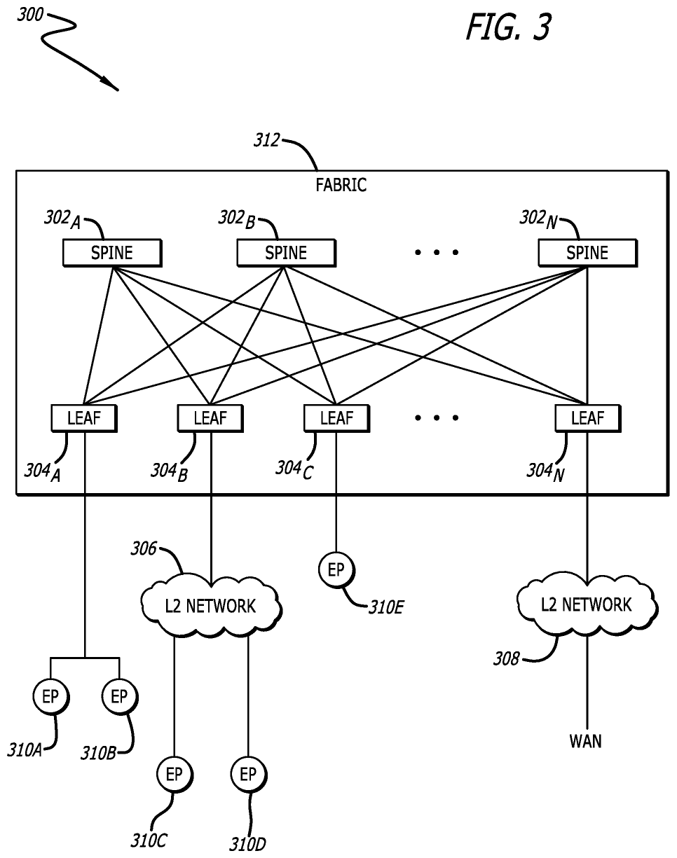

Referring to FIG. 3, a schematic block diagram of an example architecture 300 for a network fabric 312, in accordance with various embodiments of the disclosure is shown. The network fabric 312 can include spine switches 302A, 302B, . . . , 302N (collectively “302”) connected to leaf switches 304A, 304B, 304c . . . 304N (collectively “304”) in the network fabric 312. As those skilled in the art will recognize, the network fabric 312 can refer to a high-speed, high-bandwidth interconnect system that enables multiple devices to communicate with each other efficiently and reliably. It is a network topology that is designed to provide a flexible and scalable infrastructure for data centers, cloud environments, and other network elements.

Various embodiments described herein can include a leaf-spine architecture comprising a plurality of spine switches and leaf switches. Spine switches 302 can be L3 switches in the fabric 312. However, in some cases, the spine switches 302 can also, or otherwise, perform L2 functionalities. Further, the spine switches 302 can support various capabilities, such as, but not limited to, 40 or 10 Gbps Ethernet speeds. To this end, the spine switches 302 can be configured with one or more 40 Gigabit Ethernet ports. In certain embodiments, each port can also be split to support other speeds. For example, a 40 Gigabit Ethernet port can be split into four 10 Gigabit Ethernet ports, although a variety of other combinations are available.

In many embodiments, one or more of the spine switches 302 can be configured to host a proxy function that performs a lookup of the endpoint address identifier to locator mapping in a mapping database on behalf of leaf switches 304 that do not have such mapping. The proxy function can do this by parsing through the packet to the encapsulated tenant packet to get to the destination locator address of the tenant. The spine switches 302 can then perform a lookup of their local mapping database to determine the correct locator address of the packet and forward the packet to the locator address without changing certain fields in the header of the packet.

In various embodiments, when a packet is received at a spine switch 302i, wherein subscript “i” indicates that this operation may occur at any spine switch 302A to 302N, the spine switch 302; can first check if the destination locator address is a proxy address. If so, the spine switch 302; can perform the proxy function as previously mentioned. If not, the spine switch 302; can look up the locator in its forwarding table and forward the packet accordingly.

In a number of embodiments, one or more spine switches 302 can connect to one or more leaf switches 304 within the fabric 312. Leaf switches 304 can include access ports (or non-fabric ports) and fabric ports. Fabric ports can provide uplinks to the spine switches 302, while access ports can provide connectivity for devices, hosts, endpoints, VMs, or external networks to the fabric 312.

In more embodiments, leaf switches 304 can reside at the edge of the fabric 312, and can thus represent the physical network edge. In some cases, the leaf switches 304 can be top-of-rack (“ToR”) switches configured according to a ToR architecture. In other cases, the leaf switches 304 can be aggregation switches in any particular topology, such as end-of-row (EoR) or middle-of-row (MoR) topologies. The leaf switches 304 can also represent aggregation switches, for example.

In additional embodiments, the leaf switches 304 can be responsible for routing and/or bridging various packets and applying network policies. In some cases, a leaf switch can perform one or more additional functions, such as implementing a mapping cache, sending packets to the proxy function when there is a miss in the cache, encapsulate packets, enforce ingress or egress policies, etc. Moreover, the leaf switches 304 can contain virtual switching functionalities, such as a virtual tunnel endpoint (VTEP) function.

In further embodiments, network connectivity in the fabric 312 can flow through the leaf switches 304. Here, the leaf switches 304 can provide servers, resources, endpoints, external networks, or VMs access to the fabric 312, and can connect the leaf switches 304 to each other. In some cases, the leaf switches 304 can connect endpoint groups to the fabric 312 and/or any external networks. Each endpoint group can connect to the fabric 312 via one of the leaf switches 304, for example.

Endpoints 310 A-E (collectively “310”, shown as “EP”) can connect to the fabric 312 via leaf switches 304. For example, endpoints 310A and 310B can connect directly to leaf switch 304A, which can connect endpoints 310A and 310B to the fabric 312 and/or any other one of the leaf switches 304. Similarly, endpoint 310E can connect directly to leaf switch 304C, which can connect endpoint 310E to the fabric 312 and/or any other of the leaf switches 304. On the other hand, endpoints 310C and 310D can connect to leaf switch 304B via L2 network 306. Similarly, the wide area network (WAN) can connect to the leaf switches 304C or 304D via L3 network 308.

In certain embodiments, endpoints 310 can include any communication device, such as a computer, a server, a switch, a router, etc. In addition, the endpoints 310 can host virtual workload(s), clusters, and applications or services, which can connect with the fabric 312 or any other device or network, including an external network.

Although a specific embodiment for an architecture 300 is described above with respect to FIG. 3, any of a variety of systems and/or processes may be utilized in accordance with embodiments of the disclosure. For example, the architecture 300 could comprise any variety of endpoints, spine switches, and/or leaf switches. The elements depicted in FIG. 3 may also be interchangeable with other elements of FIGS. 1-2 and 4-8 as required to realize a particularly desired embodiment.

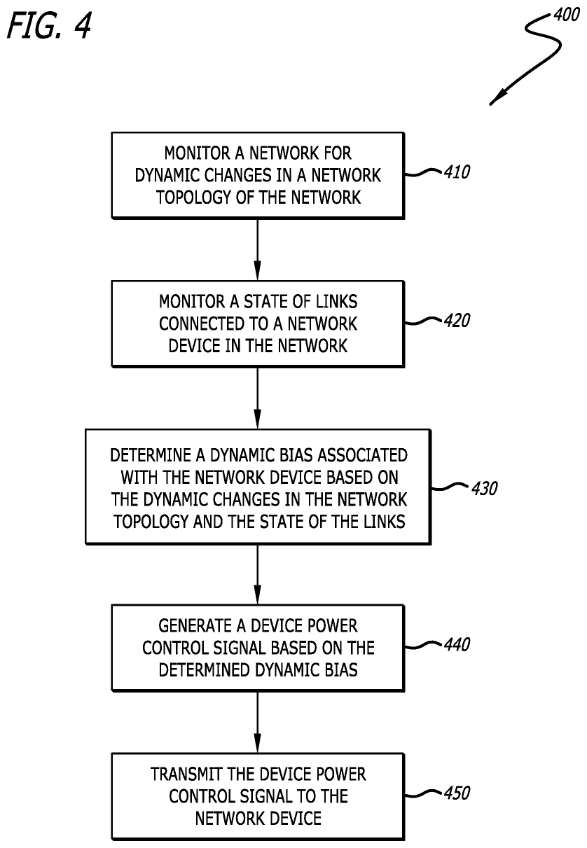

Referring to FIG. 4, a conceptual illustration of a process 400 for transmitting a device power control signal, in accordance with various embodiments of the disclosure is shown. In many embodiments, process 400 can monitor a communication network for one or more dynamic changes in a network topology of the communication network (block 410). In some embodiments, the communication network may include a plurality of network devices. In certain embodiments, one or more network devices of the plurality of network devices can be redundant network devices. In more embodiments, the dynamic changes in the network topology can include addition of one or more new network devices, removal of one or more existing network devices, powering down the one or more existing network devices, or switching the one or more existing network devices to a sleep state or a low-power state, for example. In some more embodiments, the dynamic changes in the network topology may include changes in one or more operation states of the one or more existing network devices. In numerous embodiments, the operation states of the network devices may include an on state, an off state, or a low-power state, for example.

In many embodiments, the process 400 may monitor a state of one or more links connected to a network device in the network (block 420). In some embodiments, the communication network may include a plurality of links between the plurality of network devices. In certain embodiments, a number of links of the plurality of links may be redundant links. In more embodiments, the dynamic changes in the network topology may include changes in one or more operation states of the plurality of links between the network devices. In some more embodiments, the operation states of the links can include an on state and an off state, for example.

In a number of embodiments, the process 400 can determine a dynamic bias associated with a network device based on the dynamic changes in the network topology (block 430). In some embodiments, the dynamic bias associated with the network device at a time instant can be high or relatively higher if the network device can be switched to the off state or the low-power state at that time instant, for example. In certain embodiments, the process 400 may constantly or periodically adjust the dynamic bias associated with the network device.

In various embodiments, the process 400 may generate a device power control signal based on the determined dynamic bias associated with the network device (block 440). In some embodiments, the device power control signal can be indicative of a change in the operation state of the network device. In certain embodiments, the device power control signal may indicate switching the network device off or switching the network device on. In more embodiments, the device power control signal can indicate switching the network device in the low-power state or the sleep state.

In additional embodiments, the process 400 can transmit the device power control signal to the network device (block 450). In some embodiments, the process 400 may transmit the device power control signal to the network device by utilizing a YANG protocol, an Application Programming Interface, or a secure communication protocol, for example. In certain embodiments, the process 400 may transmit the device power control signal to an intermediary network device and the intermediary network device may forward the device control signal to the network device. In more embodiments, the process 400 may receive an acknowledgement signal from the network device in response to the device power control signal received by the network device.

Although a specific embodiment for the process 400 for carrying out the various steps, processes, methods, and operations described herein is discussed with respect to FIG. 4, any of a variety of systems and/or processes may be utilized in accordance with embodiments of the disclosure. For example, the process 400 may determine the dynamic biases associated with the network devices and may accordingly signal the network devices to change the operation states based on the corresponding dynamic biases. The elements depicted in FIG. 4 may also be interchangeable with other elements of FIGS. 1-3 and FIGS. 5-8 as required to realize a particularly desired embodiment.

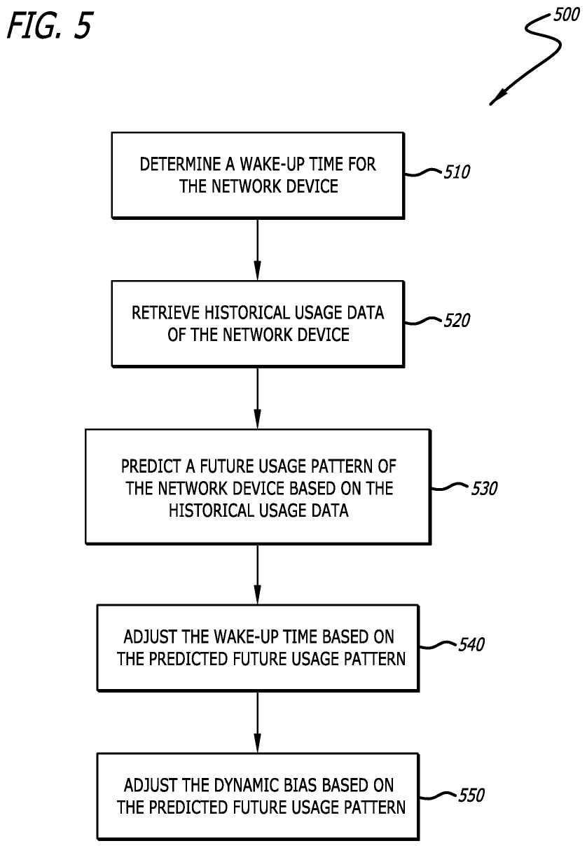

Referring to FIG. 5, a conceptual illustration of a process 500 for adjusting the dynamic bias associated with the network device, in accordance with various embodiments of the disclosure is shown. In many embodiments, the process 500 may determine a wake-up time for the network device (block 510). In some embodiments, the process 500 can dynamically adjust the wake-up time in real-time or near real-time when the process 500 detects any change in the network topology of the communication network. In certain embodiments, the device power control signal is further indicative of the wake-up time for the network device. In more embodiments, the network device can receive the device power control signal and switch the operation state of the network device to the off state, or the low-power state based on the device power control signal. Thereafter, in some more embodiments, after the wake-up time has passed, the network device can switch the operation state of the network device to the on state.

In a number of embodiments, the process 500 can retrieve historical usage data of the network device (block 520). In certain embodiments, the historical usage data may include bandwidth usage information for inbound and outbound traffic at the network device, latency information including round-trip time for packets, packet loss information, jitter, information about processor and memory usage of the network device, interface utilization of the network device, temperature and hardware health of the network device, security logs and intrusion at the network device, user activity in the network device, or power consumption by the network device, for example. In more embodiments, the historical usage data can further include utilization times of the network device, i.e., the times at which the network device was utilized. In some more embodiments, the process 500 may retrieve the historical usage data may from the network device or the controller. In numerous embodiments, the process 500 can retrieve the historical usage data from an external storage device or a database in the communication network or external to the communication network.

In various embodiments, the process 500 may predict a future usage pattern of the network device based on the historical usage data (block 530). In some embodiments, the process 500 can perform capacity and resource planning for the network device, forecasting power consumption of the network device, forecasting updates to the network device, forecasting compliance audits scheduled for the network device, forecasting application or service demand for the network device, predicting security threats for the network device, or growth in data traffic through the network device, for example. In certain embodiments, the process 500 may predict a time when the usage of the network device would exceed a predetermined threshold usage.

In additional embodiments, the process 500 can adjust the wake-up time based on the predicted future usage pattern (block 540). In some embodiments, the process 500 may adjust the wake-up time such that the network device switches on when the usage of the network device is predicted to be increased above the predetermined threshold usage. In certain embodiments, the process 500 may adjust can adjust the wake-up time based on the dynamic changes in the network topology.

In further embodiments, the process 500 may adjust the dynamic bias associated with the network device based on the predicted future usage pattern of the network device (block 550). In some embodiments, the process 500 can generate the device power control signal based on the adjusted dynamic bias such that the device power control signal is further indicative of the adjusted wake-up time. In certain embodiments, the process 500 may transmit the device power control signal to the network device. In more embodiments, the network device has a stored wake-up time in a memory within the network device. In some more embodiments, the network device may rewrite the wake-up time stored in the memory with the adjusted wake-up time. In numerous embodiments, the network device may switch the operation state after the adjusted wake-up time has passed.

Although a specific embodiment for the process 500 for carrying out the various steps, processes, methods, and operations described herein is discussed with respect to FIG. 5, any of a variety of systems and/or processes may be utilized in accordance with embodiments of the disclosure. For example, the process 500 may signal the network devices to change the operation states based after corresponding wake-up times. The elements depicted in FIG. 5 may also be interchangeable with other elements of FIGS. 1-4 and FIGS. 6-8 as required to realize a particularly desired embodiment.

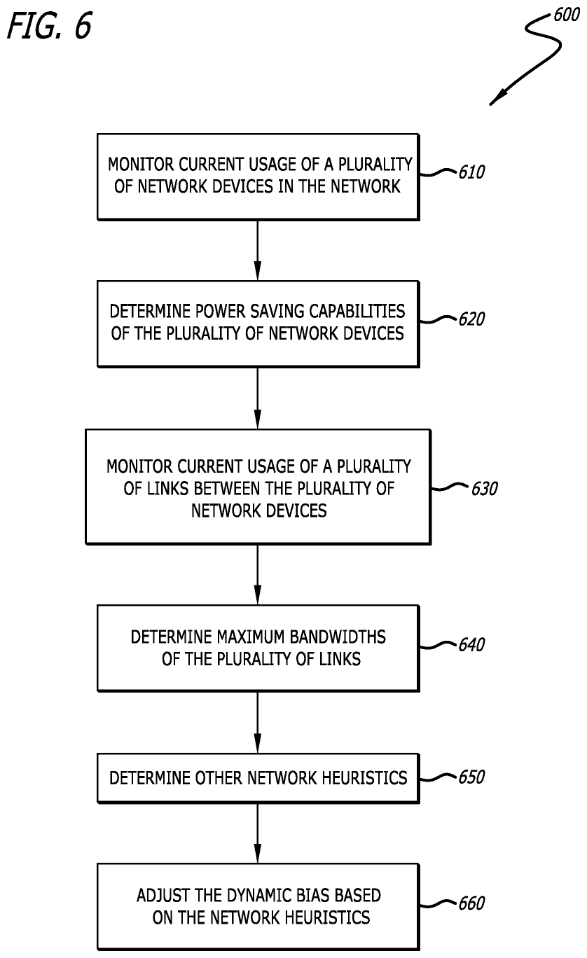

Referring to FIG. 6, a conceptual illustration of a process 600 for adjusting the dynamic bias associated with the network device, in accordance with various embodiments of the disclosure is shown. In many embodiments, the process 600 can monitor a current usage of the network device (block 610). In some embodiments, the current usage of the network device may correspond to information about data traffic through the network device. In certain embodiments, the information about the data traffic though the network device may include speed, error rate, Quality of Service, or jitter in inbound and outbound traffic at the network device. In more embodiments, current usage of the network device may include processor and memory usage in the network device.

In a number of embodiments, the process 600 can determine power saving capabilities of the plurality of network devices (block 620). In some embodiments, the process 600 can determine energy efficiency of the network device or power consumption of the network device. In certain embodiments, the process 600 can determine low-power or sleep states of the network device, or scheduled power management functions in the network device.

In various embodiments, the process 600 may monitor current usage of the plurality of links between the plurality of network devices (block 630). In some embodiments, the process 600 may implement traffic engineering for optimizing the routing of the data traffic to avoid congested links. In certain embodiments, the process 600 can implement load balancing for distributing the data traffic across the plurality of links. In more embodiments, the process 600 can implement fault detection for identifying the links that are nearing capacity or experiencing high utilization.

In additional embodiments, the process 600 can determine maximum bandwidths of the plurality of links (block 640). In some embodiments, the process 600 may determine the Quality of Service of the links. In certain embodiments, the process 600 can determine maximum speed, error rate, or jitter of the links. In more embodiments, the process 600 may determine costs of the links.

In further embodiments, the process 600 may determine other network heuristics (block 650). In some embodiments, the network heuristics for the communication network include the current usage of the network devices, the power saving capabilities of the network devices, the current usage of the links between the network devices, and maximum bandwidths of the links, along with other related parameters as described in blocks 610-640. In certain embodiments, the process 600 can determine the other network heuristics, such as, but not limited to, security parameters of the network devices, configuration settings of the network devices, user activity at the network devices, backup schedules of the network devices, recovery schedules of the network devices, and other such parameters associated with the network devices.

In many more embodiments, the process 600 can adjust the dynamic bias associated with the network device based on the network heuristics (block 660). In some embodiments, the process 600 may further generate the device power control signal based on the adjusted dynamic bias. In certain embodiments, the process 600 can transmit the device power control signal indicative of the adjusted dynamic bias to the network device.

Although a specific embodiment for the process 600 for carrying out the various steps, processes, methods, and operations described herein is discussed with respect to FIG. 6, any of a variety of systems and/or processes may be utilized in accordance with embodiments of the disclosure. For example, the process 600 may constantly adjust the dynamic bias associated with the network device based on the network heuristics or other parameters related to the network heuristics. The elements depicted in FIG. 6 may also be interchangeable with other elements of FIGS. 1-5 and FIGS. 7-8 as required to realize a particularly desired embodiment.

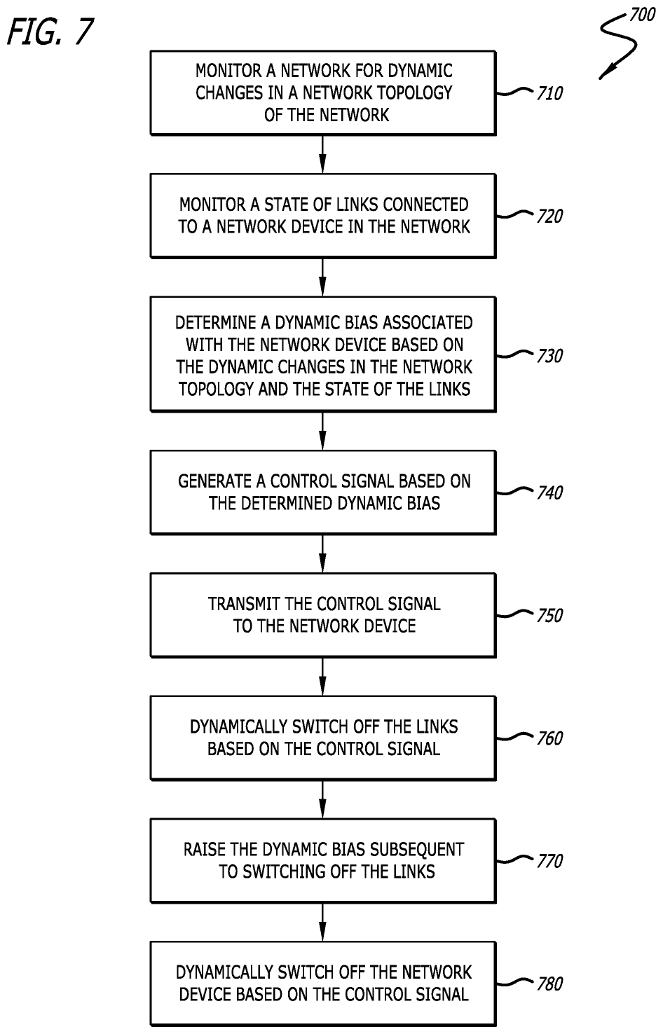

Referring to FIG. 7, a conceptual illustration of a process 700 for switching states of the one or more links connected to the network device and raising the dynamic bias associated with the network device, in accordance with various embodiments of the disclosure is shown. In many embodiments, the process 700 may monitor the communication network for the dynamic changes in the network topology (block 710). In some embodiments, the process 700 may detect the dynamic changes in the network topology in real-time or in near real-time. In certain embodiments, the process 700 can detect the dynamic changes by way of a connected network device or by way of an intermediate network device connected to the network device.

In a number of embodiments, the process 700 can monitor the state of the links connected to the network device (block 720). In some embodiments, the process 700 may determine if the links connected to the network device are switched on or switched off. In certain embodiments, the process 700 can determine if any of the links connected to the network device are essential links or redundant links.

In various embodiments, the process 700 may determine the dynamic bias associated with the network device based on the dynamic changes in the network topology (block 730). In some embodiments, the process 700 can constantly or periodically adjust the dynamic bias associated with the network device based on the dynamic changes in the network device. In certain embodiments, the process 700 may further determine the wake-up time for the network device. In more embodiments, the process 700 can also adjust the wake-up time of the network device based on the adjusted dynamic bias.

In additional embodiments, the process 700 can generate the control signal based on the determined dynamic bias (block 740). In some embodiments, the control signal may be indicative of the wake-up time or the adjusted wake-up time. In certain embodiments, the control signal may be indicative of switching the operation state of the network device. In more embodiments, the control signal can be indicative of switching the operation state of the links connected to the network device.

In further embodiments, the process 700 may transmit the control signal to the network device (block 750). In some embodiments, the process 700 can transmit the control signal to the intermediate network device and the intermediate network device can transmit the control signal to the network device. In certain embodiments, the process 700 may receive the acknowledgement signal from the network device in response to the control signal received by the network device.

In many more embodiments, the process 700 can dynamically switch off a link connected to the network device based on the control signal (block 760). In some embodiments, the control signal may be indicative of switching the operation state of the link indicated by the control signal. In certain embodiments, the network device can switch off the link indicated by the control signal or switch on the link indicated by the control signal. In more embodiments, the control signal can be indicative of switching the operation states of multiple links connected to the network device.

In many additional embodiments, the process 700 may raise the dynamic bias of the network device subsequent to switching off the link of the network device (block 770). In some embodiments, the process 700 may lower the dynamic bias of the network device subsequent to switching on the link of the network device. In certain embodiments, the dynamic bias associated with the network device at a time instant can be high or relatively higher if the network device can be switched to the off state or the low-power state at that time instant.

In many further embodiments, the process 700 can dynamically switch off the network device based on the control signal (block 780). In some embodiments, the network device can be switched off when the links connected to the network device are switched off. In certain embodiments, the network device further switches on after the wake-up time or the adjusted wake-up time indicated by the control signal is passed.

Although a specific embodiment for the process 700 for carrying out the various steps, processes, methods, and operations described herein is discussed with respect to FIG. 7, any of a variety of systems and/or processes may be utilized in accordance with embodiments of the disclosure. For example, the process 700 may dynamically switch off one or more network devices or one or more links connected to the network devices based on the corresponding one or more dynamic biases, thereby reducing the power consumption of the communication network. The elements depicted in FIG. 7 may also be interchangeable with other elements of FIGS. 1-6 and FIG. 8 as required to realize a particularly desired embodiment.

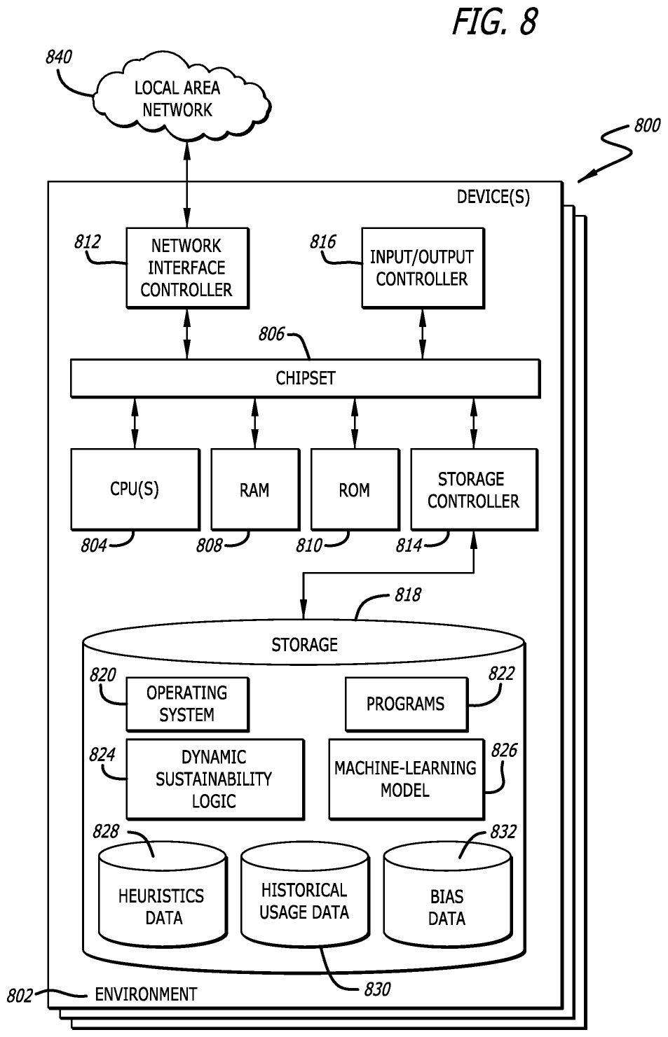

Referring to FIG. 8, a conceptual block diagram of a device 800 suitable for configuration with a dynamic sustainability logic, in accordance with various embodiments of the disclosure is shown. The embodiment of the conceptual block diagram depicted in FIG. 8 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 8 can also illustrate an access point, a switch, or a router in accordance with various embodiments of the disclosure. The device 800 may, in many non-limiting examples, correspond to physical devices or to virtual resources described herein.

In many embodiments, the device 800 may include an environment 802 such as a baseboard or “motherboard,” in physical embodiments that can be configured as a printed circuit board with a multitude of components or devices connected by way of a system bus or other electrical communication paths. Conceptually, in virtualized embodiments, the environment 802 may be a virtual environment that encompasses and executes the remaining components and resources of the device 800. In more embodiments, one or more processors 804, such as, but not limited to, central processing units (“CPUs”) can be configured to operate in conjunction with a chipset 806. The processor(s) 804 can be standard programmable CPUs that perform arithmetic and logical operations necessary for the operation of the device 800.

In a number of embodiments, the processor(s) 804 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 806 may provide an interface between the processor(s) 804 and the remainder of the components and devices within the environment 802. The chipset 806 can provide an interface to a random-access memory (“RAM”) 808, which can be used as the main memory in the device 800 in some embodiments. The chipset 806 can further be configured to provide an interface to a computer-readable storage medium such as a read-only memory (“ROM”) 810 or non-volatile RAM (“NVRAM”) for storing basic routines that can help with various tasks such as, but not limited to, starting up the device 800 and/or transferring information between the various components and devices. The ROM 810 or NVRAM can also store other application components necessary for the operation of the device 800 in accordance with various embodiments described herein.

Additional embodiments of the device 800 can be configured to operate in a networked environment using logical connections to remote computing devices and computer systems through a network, such as the network 840. The chipset 806 can include functionality for providing network connectivity through a network interface card (“NIC”) 812, which may comprise a gigabit Ethernet adapter or similar component. The NIC 812 can be capable of connecting the device 800 to other devices over the network 840. It is contemplated that multiple NICs 812 may be present in the device 800, connecting the device to other types of networks and remote systems.

In further embodiments, the device 800 can be connected to a storage 818 that provides non-volatile storage for data accessible by the device 800. The storage 818 can, for instance, store an operating system 820, applications 822, heuristics data 828, historical usage data 830, and bias data 832 which are described in greater detail below. The storage 818 can be connected to the environment 802 through a storage controller 814 connected to the chipset 806. In certain embodiments, the storage 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. The heuristics data 828 may store one or more network heuristics parameters. The historical usage data 830 may store past usages and usage parameters of a plurality of network devices. The bias data 832 may store dynamic bias values associated with the plurality of network devices.

The device 800 can store data within the storage 818 by transforming the physical state of the physical storage units to reflect the information being stored. The specific transformation of physical state can depend on various factors. Examples of such factors can include, but are not limited to, the technology used to implement the physical storage units, whether the storage 818 is characterized as primary or secondary storage, and the like.

In many more embodiments, the device 800 can store information within the storage 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 800 can further read or access information from the storage 818 by detecting the physical states or characteristics of one or more particular locations within the physical storage units.

In addition to the storage 818 described above, the device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 800. In some examples, the operations performed by a cloud computing network, and or any components included therein, may be supported by one or more devices similar to device 800. Stated otherwise, some or all of the operations performed by the cloud computing network, and or any components included therein, may be performed by one or more devices 800 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 818 can store an operating system 820 utilized to control the operation of the device 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 818 can store other system or application programs and data utilized by the device 800.

In many additional embodiments, the storage 818 or other computer-readable storage media is encoded with computer-executable instructions which, when loaded into the device 800, may transform it from a general-purpose computing system into a special-purpose computer capable of implementing the embodiments described herein. These computer-executable instructions may be stored as application 822 and transform the device 800 by specifying how the processor(s) 804 can transition between states, as described above. In some embodiments, the device 800 has access to computer-readable storage media storing computer-executable instructions which, when executed by the device 800, perform the various processes described above with regard to FIGS. 1-7. In certain embodiments, the device 800 can also include computer-readable storage media having instructions stored thereupon for performing any of the other computer-implemented operations described herein.

In many further embodiments, the device 800 may include a dynamic sustainability logic 824. The dynamic sustainability logic 824 can be configured to perform one or more of the various steps, processes, operations, and/or other methods that are described above. Often, the dynamic sustainability logic 824 can be a set of instructions stored within a non-volatile memory that, when executed by the processor(s)/controller(s) 804 can carry out these steps, etc. In some embodiments, the dynamic sustainability logic 824 may be a client application that resides on a network-connected device, such as, but not limited to, a server, switch, personal or mobile computing device in a single or distributed arrangement. In certain embodiments, the dynamic sustainability logic 824 determines dynamic changes in a network topology of a communication network and determines dynamic biases for the plurality of network devices in the communication network based on the dynamic changes in the network topology.

In still further embodiments, the device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can be configured to provide output to a display, such as a computer monitor, a flat panel display, a digital projector, a printer, or other type of output device. Those skilled in the art will recognize that the device 800 might not include all of the components shown in FIG. 8 and can include other components that are not explicitly shown in FIG. 8 or might utilize an architecture completely different than that shown in FIG. 8.

As described above, the device 800 may support a virtualization layer, such as one or more virtual resources executing on the device 800. In some examples, the virtualization layer may be supported by a hypervisor that provides one or more virtual machines running on the device 800 to perform functions described herein. The virtualization layer may generally support a virtual resource that performs at least a portion of the techniques described herein.

Finally, in numerous additional embodiments, data may be processed into a format usable by a machine-learning model 826 (e.g., feature vectors), and or other pre-processing techniques. The machine-learning (“ML”) model 826 may be any type of ML model, such as supervised models, reinforcement models, and/or unsupervised models. The ML model 826 may include one or more of linear regression models, logistic regression models, decision trees, Naïve Bayes models, neural networks, k-means cluster models, random forest models, and/or other types of ML models 826.

The ML model(s) 826 can be configured to generate inferences to make predictions or draw conclusions from data. An inference can be considered the output of a process of applying a model to new data. This can occur by learning from at least the heuristics data 828, the historical usage data 830 and the bias data 832 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 826 may be generated by human/administrator verifications or may compare predicted outcomes with actual outcomes.

Although a specific embodiment for a device suitable for configuration with a dynamic proxying logic for carrying out the various steps, processes, methods, and operations described herein is discussed with respect to FIG. 8, any of a variety of systems and/or processes may be utilized in accordance with embodiments of the disclosure. For example, the device may be in a virtual environment such as a cloud-based network administration suite, or it may be distributed across a variety of network devices or switches. The elements depicted in FIG. 8 may also be interchangeable with other elements of FIGS. 1-7 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a memory communicatively coupled to the processor; and
a dynamic sustainability logic, configured to:
monitor a network comprising a plurality of network devices, for one or more dynamic changes in a network topology of the network;
monitor a state of one or more links connected to at least one network device of the plurality of network devices;
determine a dynamic bias associated with the at least one network device based on the one or more dynamic changes and the state of the one or more links; and
generate a device power control signal based on the determined dynamic bias, wherein the device power control signal is indicative of dynamically switching an operation state of the at least one network device.

2. The device of claim 1, wherein the dynamic sustainability logic is further configured to transmit the device power control signal to the at least one network device.

3. The device of claim 2, wherein the at least one network device dynamically switches the operation state based on the device power control signal.

4. The device of claim 3, wherein the operation state includes an on state, an off state, or a low-power state.

5. The device of claim 4, wherein the dynamic sustainability logic is further configured to determine a wake-up time for the at least one network device based on the dynamic bias.

6. The device of claim 5, wherein the device power control signal is further indicative of the wake-up time for the at least one network device.

7. The device of claim 6, wherein the at least one network device switches on after the wake-up time based on the device power control signal.

8. The device of claim 5, wherein the dynamic sustainability logic is further configured to:
retrieve historical usage data of the at least one network device;
predict a future usage pattern of the at least one network device based on the historical usage data; and
adjust the dynamic bias based on the predicted future usage pattern of the at least one network device.

9. The device of claim 8, wherein the dynamic sustainability logic is further configured to adjust the wake-up time based on the predicted future usage pattern of the at least one network device.

10. The device of claim 1, wherein the dynamic sustainability logic is further configured to:
monitor network heuristics for the network; and
adjust the dynamic bias based on the network heuristics.

11. The device of claim 10, wherein the network heuristics include one or more of:
current usage of the plurality of network devices,
power saving capabilities of the plurality of network devices,
current usage of a plurality of links between the plurality of network devices, or maximum bandwidths of the plurality of links.

12. The device of claim 1, wherein the dynamic sustainability logic is further configured to adjust the dynamic bias such that the dynamic bias is raised when a link of the one or more links connected to the at least one network device is switched off.

13. The device of claim 1, wherein the dynamic sustainability logic is further configured to monitor the one or more dynamic changes comprising a change in a number of the plurality of network devices or a change in a number of a plurality of links between the plurality of network devices.

14. A method, comprising:
monitoring a network comprising a plurality of network devices, for one or more dynamic changes in a network topology of the network;
monitoring a state of one or more links connected to at least one network device of the plurality of network devices;
determining a dynamic bias associated with the at least one network device based on the one or more dynamic changes and the state of the one or more links;
generating a device power control signal based on the determined dynamic bias, wherein the device power control signal is indicative of dynamically switching an operation state of the at least one network device; and
transmitting the device power control signal to the at least one network device.

15. The method of claim 14, further comprising:
retrieving historical usage data of the at least one network device;
predicting a future usage pattern of the at least one network device based on the historical usage data; and
adjusting the dynamic bias based on the predicted future usage pattern of the at least one network device.

16. A device comprising:
a processor;
a memory communicatively coupled to the processor; and
a dynamic sustainability logic, configured to:
monitor a network comprising a plurality of network devices, for one or more dynamic changes in a network topology of the network;
monitor a state of one or more links connected to at least one network device of the plurality of network devices;
determine a dynamic bias associated with the at least one network device based on the one or more dynamic changes and the state of the one or more links;
generate a control signal based on the determined dynamic bias; and
transmit the control signal to the at least one network device.

17. The device of claim 16, wherein the control signal is indicative of dynamically switching an operation state of the at least one network device.

18. The device of claim 17, wherein the at least one network device dynamically switches the operation state based on the control signal.

19. The device of claim 16, wherein the control signal is indicative of dynamically switching the state of the one or more links connected to the at least one network device.

20. The device of claim 19, wherein the at least one network device dynamically switches on or switches off the one or more links based on the control signal.
